(19) United States
(12) Patent Application Publication
(10) Pub. No.: US 2005/0278295 A1
(43) Pub. Date: Dec. 15, 2005

(54) Systems and methods for creating a database for accounting purposes

(76) Inventors: Kerstin Bernet, Bammental (DE); Werner Liebold, Wiesloch (DE); Georg Dopf, Schwetzingen (DE); Ruediger Raubeck, Ettlingen (DE); Andreas Reccius, Walldorf (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/137,531

(22) Filed: May 26, 2005

(30) Foreign Application Priority Data
May 29, 2004 (EP) 04012830.8
Aug. 21, 2004 (EP) 04019878.0

(51) Int. Cl. G06F 7/00

(52) U.S. Cl. 707/1

(57) ABSTRACT

A database is created for accounting purposes, which can be used to prepare financial statements for the organizational units of an enterprise. According to one method, document data records are saved from posting documents to a document database. The document data records include a document header and a data part. The data part includes entries for at least two items each of which include a posting amount and an account assigned thereto. Totals may be calculated from one or more posting amounts of the document data records saved, for the accounts assigned thereto. Furthermore, the totals may be saved to totals entries of a totals table.

This application claims the benefit of priority from European Patent Application No. 04012830.8, filed May 29, 2004, and European Patent Application No. 04019878.0, filed Aug. 21, 2004. The entire contents of EP 04012830.8 and EP 04019878.0 are expressly incorporated herein by reference to their entireties.

### BACKGROUND

I. Technical Field

The present invention generally relates to database systems and related methods. More particularly, the invention relates to a computer-implemented systems and methods for the creation of a database for accounting purposes, such as for preparing financial statements of an enterprise.

II. Background Information

Today, many corporate groups must comply with a plurality of statutory accounting principles when preparing and publishing their annual financial statements. For example, a German group listed on a US stock exchange must submit a financial statement under US-GAAP and/or IAS ,as well as under HGB. It is possible that further financial statements are necessary, for example, for subsidiaries in Asian countries, according to local rules. In addition to these financial statements prescribed by law, the preparation of financial statements for various organizational units of an enterprise that are as informative as possible are required for providing the management with as comprehensive a picture as possible on the development of individual projects or company segments or products or product groups. For example, these organizational units may be cost centers, profit centers, or segments or lines of business. In the media industry, such an organizational unit may, for example, involve a single title or, in the insurance industry, a single type or line of insurance business.

All company reports of a corporate group are based on business transactions, each of which is to be recorded by a document. For example, a business transaction may be an incoming supplier invoice or the withdrawal of goods from the stores for production purposes. Large corporate groups incur thousands or hundreds of thousands of transactions each day. For that reason, accounting for a large corporate group can be accomplished only with the use of data processing systems if related efforts are to be justifiable.

Statutory provisions do not require that a separate financial statement be prepared for each of the organizational units of an enterprise. According to the state of the art, internal reports on organizational units of an enterprise, such as projects or cost centers, are therefore often prepared on the basis of data that is entered in the central accounting database of an enterprise in part only and is supplemented by estimates of expenses or earnings of the organizational unit interested.

Since many business transactions involve a plurality of organizational units of an enterprise, the data for separate accounting on individual organizational units of an enterprise is usually not available in the database of the bookkeeping department of a corporate group. If accounting on individual organizational units of an enterprise is required for internal reports, the accounting is accomplished at regular intervals and on the basis of separate databases that are not integrated in the database of the bookkeeping department of the corporate group. This approach is very flexible because books can be kept, if necessary, for each single project and as precisely as desired, in a database that, supplemented by estimates, can form the basis of internal reports. Since this database, however, is not integrated in the database of the bookkeeping department of the corporate group, efficient control is hindered, thus causing errors. In particular, the various databases would have to be matched to each other in a work-intensive manner to ensure that the picture provided of the various organizational units of a corporate group is consistent.

Therefore, a way of improving databases for accounting purposes is needed such that accounts for various organizational units of a corporate group can be made up and balanced with less efforts.

### SUMMARY

According to an embodiment of the present invention, a computer-implemented method is provided for creating a database for accounting purposes, such as for preparing financial statements of an enterprise. The method comprises saving document data records from posting documents to a document database. The document data records may comprise a document header and a data part, the data part comprising entries for at least two items each of which comprises a posting amount and an account assigned thereto. Prior to calculating the totals for the totals entries of the totals table, at least one item of the document data record is assigned proportionately to two or more organizational units of the enterprise, from the at least one item. Partial items may be generated according to computer-implemented rules. In the partial items, the posting amount of the item may be subdivided in proportionate partial amounts and each partial item, along with its partial amount, may be assigned to one of the organizational units. At least one total is saved to each of the totals entries for each organizational unit to which one or more partial items are assigned. The totals for the organizational units are only calculated with posting amounts originating from items or partial items that are assigned to the particular organizational unit concerned. Furthermore, totals are calculated from one or more posting amounts of the document data records saved for the accounts assigned thereto and the totals are saved to totals entries of a totals table.

In accordance with another embodiment of the present invention, a computer-readable medium is provided that comprises software sections or modules which can be loaded to the memory of a digital computer and which can be used to carry out the steps of a method when the software sections are run on a computer. The method comprises saving document data records from posting documents to a document database. The document data records may comprise a document header and a data part, the data part comprising entries for at least two items each of which comprises a posting amount and an account assigned thereto. Prior to calculating the totals for the totals entries of the totals table, at least one item of the document data record is assigned proportionately to two or more organizational units of the enterprise, from the at least one item. Partial items may be generated according to computer-implemented rules. In the partial items, the posting amount of the item may be subdivided in proportionate partial amounts and each partial item, along with its partial amount, may be assigned to one of the organizational units. At least one total is saved to each of the totals entries for each organizational unit to which one or more partial items are assigned. The totals for the organizational units are only calculated with posting amounts originating from items or partial items that are assigned to the particular organizational unit concerned. Furthermore, totals are calculated from one or more posting amounts of the document data records saved for the accounts assigned thereto and the totals are saved to totals entries of a totals table.

It is understood that both the foregoing general description and the following detailed description are exemplary and explanatory only and are not restrictive of the embodiments of the invention, as claimed. The description of aspects, features and/or advantages of particular embodiments should not be construed as limiting other embodiments or the claims.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 shows an exemplary input mask for document data records;

FIG. 2 shows a exemplary document entry view of a document data record;

FIG. 3 shows a exemplary view of the document data record that is dependent on a general ledger;

FIG. 4 is a diagram illustrating an exemplary document split by the example of an invoice accounting entry;

FIG. 5 is a diagram illustrating an exemplary document split by the example of a payment accounting entry; and

FIG. 6 is a diagram illustrating an exemplary document split.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

In methods consistent with embodiments of the present invention, data keeping in a database is simplified and work-intensive matching of account data to values is not necessary. Any relevant information on any business transaction of an enterprise can be entered in a single database. Based on this database, group financial statements according to statutory accounting principles as well as financial statements for internal reports on various organizational units, such as cost centers, segments, product groups, products, etc. can be prepared and published. Furthermore, the simplified data-keeping allows cost and earnings of individual organizational units of an enterprise to be entered in a more precise manner. In particular, the financial statements of different organizational units provide a consistent picture both in relation to each other and to the group financial statement, without different databases having to be matched to each other.

When entering a business transaction, the bookkeeper, for example, enters in the data part of a document data record the organizational unit or units of an enterprise involved therein. In accordance with an embodiment of the present invention, a method may be provided that does not require the generation of additional accounts in the database, in order to enter the cost and/or earnings of the individual organizational units of an enterprise.

If a business transaction involves a plurality of organizational units, a plurality of document items can be entered in the data part of the document data record, for example by means of a screen mask provided. In the document items, a partial amount on one of the two accounts, i.e., account and offset account, may be assigned to the particular organizational unit concerned. Additional document items with the appropriate partial amounts for the associated (offset) account do not have to be entered.

Computer programs consistent with embodiments of the present invention may be provided to automatically generate further document items or partial items. In the document or partial items, the posting amount is, in relation to the partial amounts entered, allocated to the particular organizational unit concerned for the respective other account (offset account) as well.

In accordance with an embodiment of the invention, document items can also be subdivided in partial items according to a key defined for business transactions of a specific type. For example, it is appropriate to use a defined key for the subdivision, if business transactions from the overhead department, such as electricity or water bills, are concerned, which can, in this manner, be assigned to the different organizational units of an enterprise in partial amounts on an account and a offset account, without every single invoice having to be subdivided manually.

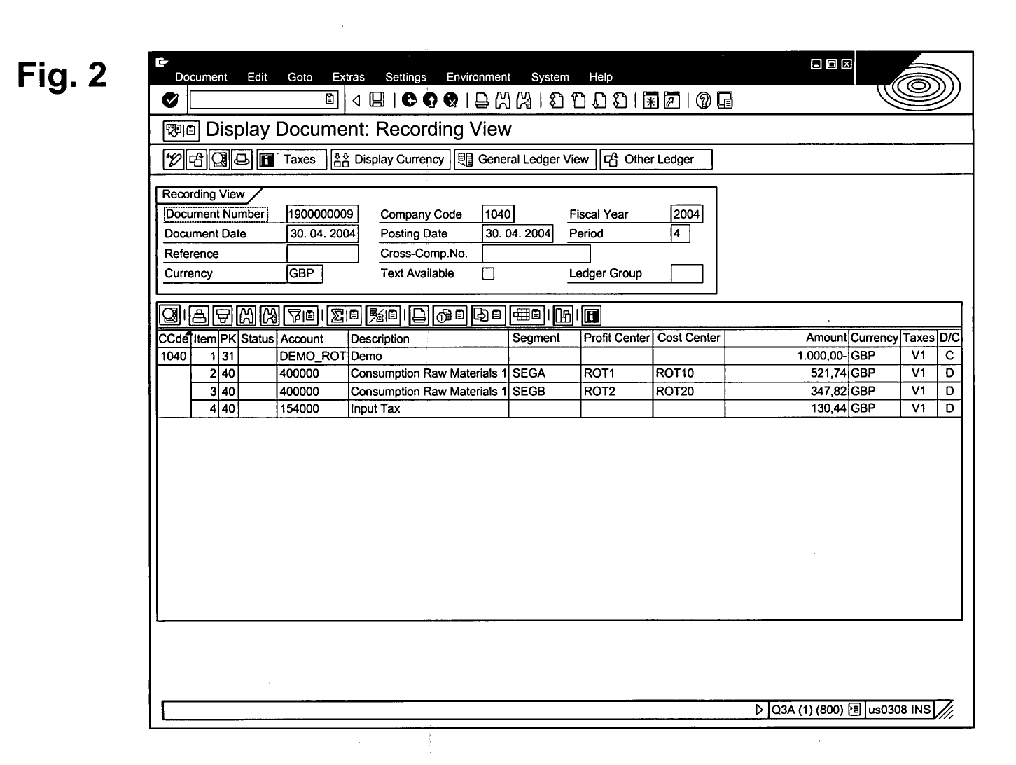

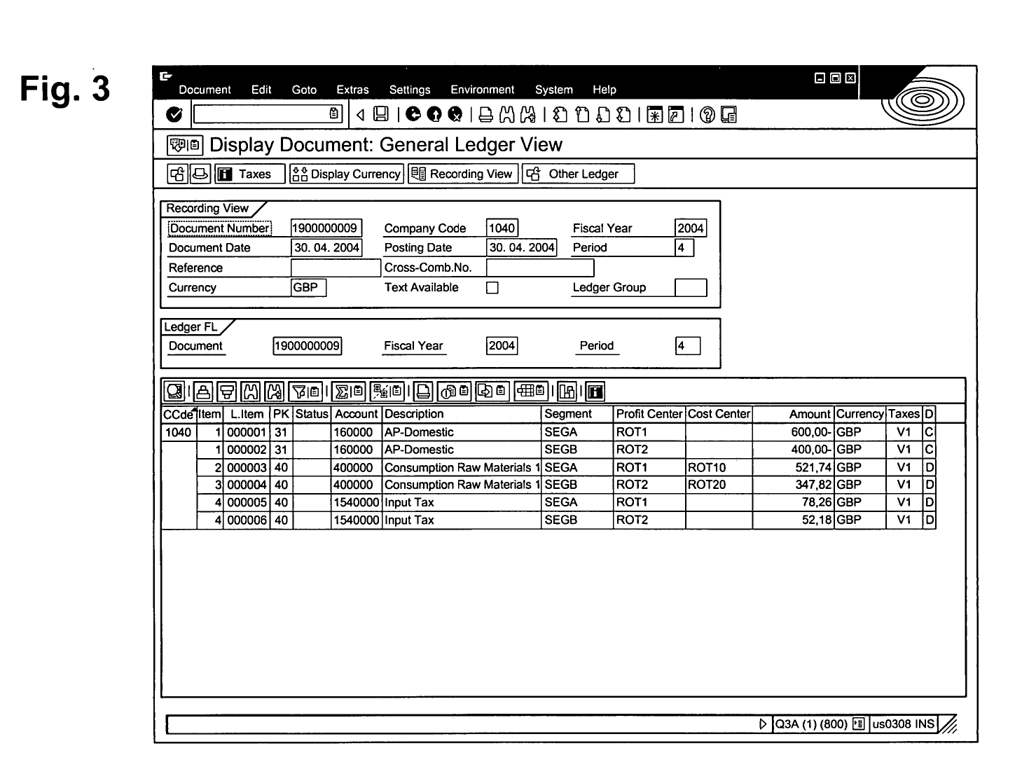

A document entry view (as shown by the example FIG. 2) shows the document at the granularity the bookkeeper used to manually enter the document in a recording mask or at the granularity at which the document was received via an interface in case of automatic entry. The view depending on the general ledger (as shown by the example of FIG. 3) shows the fields the content of which is saved for updating the totals of the general ledgers concerned. As described below, a document data record corresponding to a posting document may be generated in a document database for each business transaction. Document data records are sometimes also referred to as single item entries.

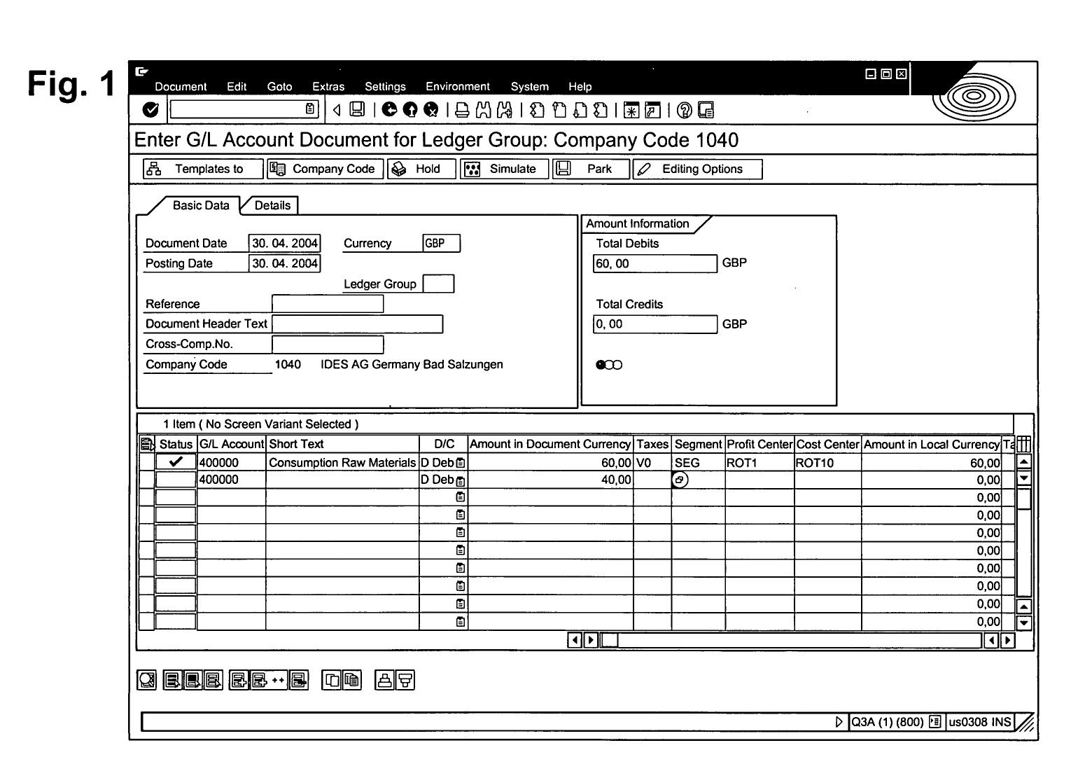

FIG. 1 shows an example of an input mask or graphical user interface (GUI) that comprises a plurality of input fields. The input mask may be generated by a computer program on a screen of a computer system. The input fields may be used to enter the data related to a document data record for the purposes entering a business transaction.

In accordance with one embodiment, a document data record comprises a document header and a data part. In the input mask, the input fields of the document header are arranged above the input fields of the data part such that they are graphically set off against each other. In the example, the title of the data part is “Item”. The input fields of the document header of the input mask are provided for entry of a company code identifying the associated company (or subsidiary), a document date, and a posting date. It is also possible to save an external reference number and/or additional information in the document header. It is not necessary to enter the information saved in the document header of a document data record as a whole via the input mask. For example, the computer program can automatically assign a unique document number and save it to the header part. Furthermore, the computer program can determine the appropriate posting period (e.g., quarter or fiscal year) on the basis of the document date and also save it in the document header.

In addition, the input mask comprises the “Ledger Group” input field to permit preparation of financial statements for a plurality of different general ledgers each complying with different statutory accounting principles. This input field can be used to specify the general ledgers to which the associated document data record is relevant. If a business transaction must be posted under different statutory accounting principles, a plurality of document data records which are to be considered for each of the different statutory accounting principles and, thus, to be assigned to each of the different general ledgers are generated in a simple procedure.

The fact that a separate general ledger is kept for each of the various statutory accounting principles allows the creation of a database which can be used to generate the accounts according to different statutory accounting principles, without much effort being necessary. Unless an entry is made in the “Ledger Group” input field, the related single item entry is automatically considered for all general ledgers, i.e., it is assumed that it is relevant to all statutory accounting principles.

In the simplest case, it suffices to fill in a single line of the input fields of the data part by specifying one account and one posting amount. In simple cases and if the setting of the data processing system is appropriate, the related offset account can be supplemented automatically, with the result that the document data record reflects a complete entry formula. As a matter of course, the (offset) account can also be entered manually.

FIG. 2 shows an exemplary document entry view of a document data record. The data part of a document data record comprises a plurality of items each being represented as a line and each specifying a posting account and a posting amount and the like. In the exemplary embodiment shown, payables are credited to the DEMO_ROT vendor in the first line. In lines 2 and 3, the offset posting of the corresponding expense is enered in account 400000 in two partial amounts and allocated to segments SEG A and SEG B. The expense is unequally allocated to the two SEG A and SEG B segments. Furthermore, in line 4, an input tax is debited to account 154000, with the result that the amounts debited and credited are the same.

In the exemplary embodiment shown, a part of the information already contained in the document header is additionally saved once more to the data part, thus facilitating a database search. The redundant information that is additionally saved to the data part comprises, in particular, the company code and the currency used for the entry. Further, input fields of the input mask of the data part can be used to specify a posting key (PK) and information on the tax treatment of the entry, for example, via the value-added-tax rate to be applied.

The data part of the document data record which is illustrated by lines 1 through 4 of the document entry view shown in FIG. 2 is a general data part. This data part is used to save posting information that is not dependent on a general ledger, but is relevant to all general ledgers concerned. Accordingly, there is no entry in the “Ledger Group” field in the document entry view shown in FIG. 2. Although relevant to all general ledgers, the document data record shown in FIG. 2 is not adequately detailed to comply with all statutory accounting principles. For example, IAS or US-GMP principles require that a segmental disclosure be prepared for the appendix to a group financial statement. This is not necessarily required for a local financial statement.

Accordingly, a comprehensive segmental disclosure preferably requires that a business transaction involving a plurality of segments be allocated to the various segments both on the debit side and the credit side. However, an allocation of the expense as it is shown in the document entry view of FIG. 2 suffices for some of the statutory accounting principles and internal reports.

To prepare a full balance sheet for the various segments of an enterprise, as it is, for example, required under IAS, partial items are generated from the items of a document data record involving a plurality of organizational units of the enterprise. The partial items are used to subdivide the posting amount of the respective items in proportionate partial amounts. Along with its partial amount, each partial item is assigned to the particular organizational unit of the enterprise.

A data part that is specific to a general ledger can, in addition, be generated from the general data from of a document data record. The general-ledger-specific data part is used to save posting information that is derived from the general data part and is relevant to the particular general ledger. If the expense of an invoice is distributed over a plurality of organizational units (segments SEG A and SEG B in the example shown), document lines each allocating a partial posting amount to the particular segment are generated for each posting amount. This can be achieved automatically or initiated manually. The particular units can be specified explicitly in the general data part of a document data record or can be derived automatically from the specification of more specific organizational units of an enterprise.

The amount of payables to a vendor and the amount of an input tax can be transferred from the incoming invoice while documents are entered. For that reason, it is, for the time being, not necessary to allocate the amounts to the particular segments (see lines 1 and 4 in FIG. 2). When a general-ledger-specific data part is generated for a document data record, the general data part of the document data record is first checked for partial posting amounts that are allocated to different organizational units (e.g., segments) of an enterprise. If this is the case, posting amounts are, in the general-ledger-specific data part, allocated to the corresponding organizational units in proportion to the partial posting amounts. In the example shown, these are the amount of the payables to the vendor (FIG. 2, line 1) and the amount of the input tax (FIG. 2, line 4).

These items are automatically subdivided while they are posted. This process includes an automatic check to determine for which general ledgers the segments specified in the general data part are relevant as additional allocation to an account. A general-ledger-specific data part supplementing the document data record is generated for each of these general ledgers, by subdividing one or more items in partial items.

FIG. 3 shows an example of such a general-ledger-dependent view (general ledger view) of the document data record illustrated by means of the recording view shown in FIG. 2. As can be seen, this general ledger view shows all of the posting items such that they are each allocated to the two partial segments SEG A and SEG B as partial amounts. This results in a total of six posting lines. The 2^{nd} column in FIG. 3 specifies the respective line of the recording view forming the basis of each of these posting lines.

An advantage of this procedure is that the document header and the general data part of a document data record must be saved in the database only in a single place and that the general-ledger-specific data parts can be generated automatically if necessary. In this manner, the data volume to be managed by the database can be reduced. Where general ledgers do not require any allocation of the posting amounts to segments or require such allocation in part only, general-ledger-specific data parts containing a correspondingly lower number of items (document lines) are generated.

A totals entry containing in a totals data part a total of posting amounts of a posting account of the document data records can be generated in the totals table for each general ledger. These totals entries can be updated constantly so that even new document data records are also taken into consideration. However, they can also be completely recalculated at periodic intervals or at preset points in time.

A logical key can be assigned to each totals entry, the key specifying the criteria used to sum up the posting amounts in the particular totals entry. The key may comprise a number of logical key fields specifying, for example, a posting account, a profit center, a segment, a posting period, or the like as such criteria. In other words, the key specifies which posting amounts are to be summed up from which posting account, i.e. which document items are to be taken into consideration.

Based on the totals entries, the respective general ledgers can, in addition, be valued by segments by including the allocation to a specific segment in the totals table via a key field. This is called segmental disclosure. As a matter of course, such a procedure is not restricted to segments only, but can also be applied to further entities, such as profit centers as internal areas of responsibility, or to branch-specific entities, such as titles in the media industry. Hence, a method according to the invention permits the use of reports as they are required for the financial statement of a corporate group, for example, for a balance sheet, a segmental disclosure, or internal reports on other entities.

Due to their usual architecture, databases are limited to a specific number of key fields, e.g., to 16. In order to allow—in the example—more than sixteen key fields to be nevertheless assigned to a totals entry, each key contains seven numbers each of which is compiled to a specific combination of types of logical key fields by means of seven key fields assigned to the numbers. In this manner, almost any number of logical key fields can be implemented. Thereby, totals entries can be generated for a correspondingly large number of criteria, such as account, profit center, segment, posting period, or the like. As a matter of course, it is also possible to use a higher or lower number of key tables containing the corresponding number of numbers on the key. In particular, it is also possible to specify user-defined further criteria and to include such criteria in the key tables.

Consistent with embodiments of the invention, partial amounts of a posting amount can be allocated to different segments, profit centers or other organizational units. As a result, cost and earnings of the various segments can be easily determined by evaluating the document data records saved in the database. The data part of a document data record can also easily contain a significantly greater number of input fields per line than in the figures shown. Thereby, individual titles for the media industry can, for example, be entered in addition to segments, and segmental disclosure or internal reporting on various projects can be achieved as detailed as desired by evaluating the various entries in the database.

In the exemplary embodiment shown in FIGS. 1 through 3, a computer program consistent with embodiments of the invention may generate two additional lines for the document data record. In these lines, GBP 400.00 and GBP 600.00 are allocated to segments SEG A and SEG B respectively on account 1600. Where document splits with partial amounts being allocated to different profit centers are concerned, it suffices to enter the profit centers in the general ledger account lines (usually expense or earnings lines). The data processing program may automatically generate an appropriate document splitting for the other account(s). Thereby, it is, in principle, also possible to prepare a balance sheet for individual profit centers, segments or other organizational units of an enterprise.

Whether the data forming the base of a document data record is entered manually via an input mask or received electronically via an interface is not of any relevance to document splitting. It is, however, advantageous if document splitting is carried out prior to calculating totals for the totals entries of the totals table. In this manner, it is ensured that all items are subdivided in partial items to the extent required, before the contents of the document data records are evaluated for accounting purposes. For that reason, the partial items are not only available for segment accounting purposes, but can be made generally accessible in the central accounting database of the enterprise. Document splitting is, preferably, achieved by means of a split routine integrated in the interface of the computer system used for receiving external data for document data records. If accounting data is transferred from outside, for example. via the Internet, document splitting can be carried out online.

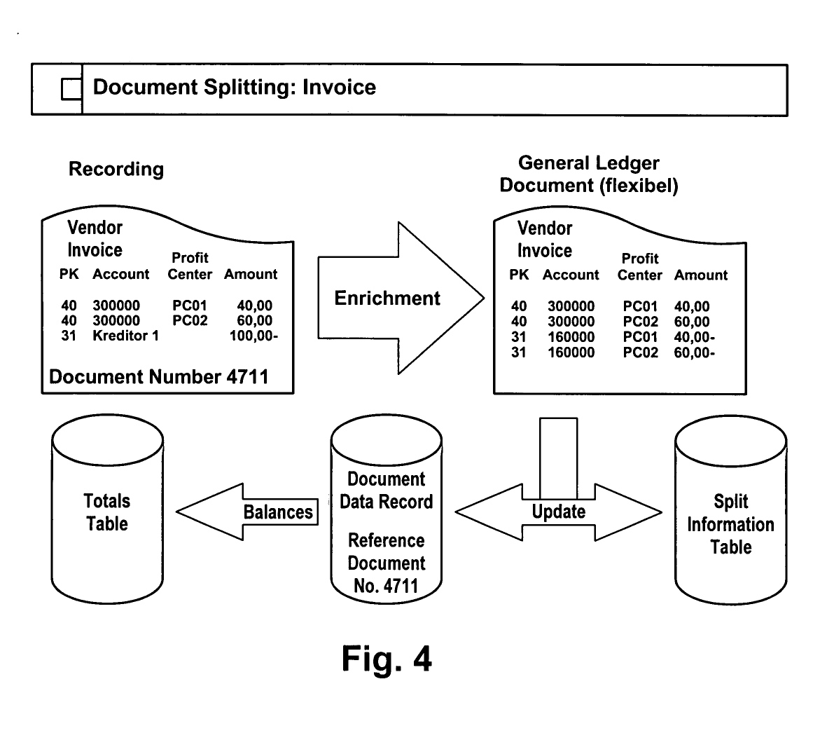

The steps that may be used to perform a document split are illustrated in the exemplary embodiment of FIG. 4. In this example, a document split is performed in reference to an incoming invoice. In a first step, a document data record having the document number 4711 is generated by means of an input mask (e.g., similar to that shown in FIG. 1). To achieve this, the bookkeeper enters three items in the form of document lines for the document data record. One document line is used to post payables amounting to EUR 100.00 to the “Vendor” account. The other two document lines are used to post expenses corresponding to the partial amounts of EUR 40.00 and EUR 60.00 to account 300000 (to the cost centers PC01 and PC02 respectively).

Using the “Vendor Invoice” business transaction specified in the header, the data processing program detects that the payables are to be split in proportion to the expense amounts. For that reason, a data processing program uses this data to generate, in an enrichment step, a complete document data record, which is referred to as general ledger document in the example of FIG. 3. The complete document data record in the general ledger now also contains the general ledger account 160000 pertaining to the “Vendor” account, wherein the posting amount of EUR 100.00 is allocated to the cost centers PC01 and PC02 respectively in proportion to the partial amounts on account 300000. This complete document data record is saved in a document database, wherein an additional entry is generated in a split information table, the entry indicating the document split in document data record 4711.

The split information table can be used to additionally save the partial amounts of the partial items generated or their proportions with specification of the organizational units assigned thereto. It is, however, also possible to refer to rules to be used for allocating the amounts, the rules being filed somewhere else in the database. In the present example, this means that the information saved to the split information table indicates that, in document data record 4711, a partial amount of EUR 40.00 is allocated to cost center PC01 and a partial amount of EUR 60.00 is allocated to cost center PC02. The time when the document split was carried out, that is when partial items were generated to enrich the data part of the document data record, can be saved in the document header of the document data record and in the split information table.

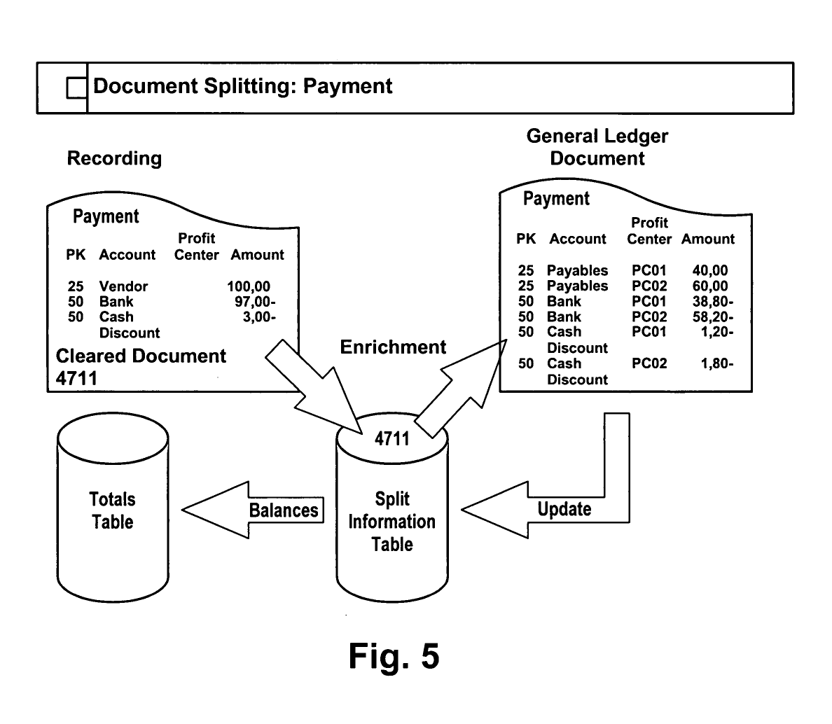

FIG. 5 illustrates how a payment effected in response to the invoice forming the basis of posting document 4711 may be treated. In the example shown in FIG. 5, it is assumed that a cash discount of 3% is allowed in case of a short-term payment. Herein, the payment amount of EUR 97.00 on the credit side of the “Bank” account results in a balance amounting to EUR 100.00 on the debit side of the “Vendor” account and in cash discounts earned on the credit side of the “Cash Discount” account.

It is advantageous that the bookkeeper, while entering this payment, does not have to be concerned about allocating the posting amounts to the PC01 and PC02 cost centers. It is sufficient to enter a reference to the document, e.g., to enter in the “Cross-Company Number” input field (abbreviated “Cross-Comp. No.” in FIG. 1) of the input mask shown in FIG. 1 the document number 4711 of the posting document used to record the invoice which has meanwhile been paid. A corresponding input field—“Cross-Company Number” in the example—preferably belongs to the document header of the document data record.

After the bookkeeper has entered this data in the database using the input mask, the data processing program according to the invention enriches the document data record—as illustrated in FIG. 5. To this end, the numbers of the documents to be balanced are used to read the related information out of the split information table and to generate in the balancing document the appropriate partial items for the various organizational units.

On the debit account, the posting amount of EUR 100.00 is, in partial amounts of EUR 40.00 and EUR 60.00, allocated to profit centers PC01 and PC02 respectively. The same ratio of 40 to 60 is also used to allocate the posting amount of EUR 97.00 of the “Bank” account to profit centers PC01 and PC02. On the “Bank” account, a partial amount of EUR 38.80 is, therefore, allocated to profit center PC01 and a posting amount of EUR 58.20 to profit center PC02, as can be seen from FIG. 5. The same ratio is used to allocate the posting amount of EUR 3.00 of the “Cash Discount” posting account in partial amounts of EUR 1.20 and EUR 1.80 to the two profit centers PC01 and PC02 respectively.

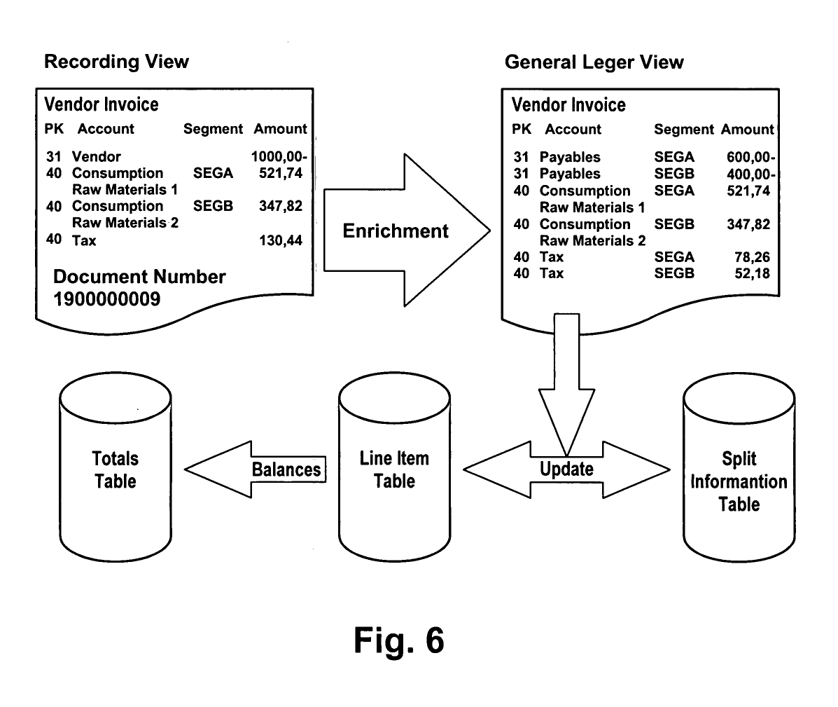

The steps that may be used for a document split are illustrated in more detail in the example of FIG. 6. In a first step, a bookkeeper generates a document data record having the document number 1900000009 by means of the input mask shown in FIG. 1, for example for the business transaction of a vendor invoice. To achieve this, the bookkeeper enters four items (document lines).

In the first document line, payables amounting to GBP 1,000.00 are entered for the “DEMO_ROT” vendor. In the following line, an amount of GBP 521.74 is entered for raw material 1 which is assigned to segment SEG A. In line 3, an expense amounting to GBP 374.82 is entered for raw material 2 and allocated to segment SEG B. Either expense is entered in account 400000. In total, the invoice amount of GBP 1,000.00 contains an input tax amounting to GBP 130.44, which is listed in document line 4. Using the “Vendor Invoice” business transaction specified in the document header of the document data record, the online splitter pertaining to the program according to the invention detects that both the payables (line 1) and the tax (line 4) are to be allocated to the segments involved, i.e. SEG A and SEG B, in proportion to the expense amounts (line 2 and line 3). Based on this data, a splitter program generates, in an enrichment step, two additional document lines, for example for a general ledger under IAS, as can be seen in FIG. 3.

In proportion to the partial amounts on account 400000 (see FIG. 3), the posting amount of GBP 1,000.00 is allocated to the individual segments SEG A and SEG B by supplementing the complete document data record with the specific data part. This complete document data record is saved in a document database, wherein an additional entry is generated in a split information table, the entry indicating the document split for posting document 1900000009. In the next step, totals entries of a totals table are generated from the document data records of the document database.

To ensure that an individual document data record is balanced, the same posting amount must be posted to the account and the related offset account of the document data record. Similarly, the debit and credit sides of a balance sheet must be balanced. This is ensured for the overall balance sheet of an enterprise by balanced accounting data records. If, however, it is intended to prepare a balance sheet for individual organizational units of the enterprise, transactions among various organizational units might occasionally happen to be entered incompletely. In this case, the accounts and offset accounts on the level of the individual organizational units of the enterprise will not be balanced.

If, for example, segment A leaves some of its material supplies to segment B (e.g., 1000 screws), then this does not have any effect on the corporate balance sheet. The preparation of separate balance sheets for segments A and B requires more than merely entering this material flow in a material account which is, for example, kept via a common store. The material flow must, in addition, be entered in a offset account related to the material account, in order that expense and earnings for the segments involved can be entered in a balance sheet.

For that reason, computer-implemented methods consistent with embodiments of the present invention may comprise a test routine which checks at least one, preferably all, of the organizational units of the enterprise for at least one account, preferably for all accounts, as to whether the total on the particular account that is assigned to a specific organizational unit is equal to the total that is assigned to the organizational unit on the related offset account. If this is the case, the account and the offset account assigned to the particular organizational unit concerned are balanced. If this is not the case, the test routine generates a corrective accounting data record which contains the missing offset posting in an item, with the result that the account and the offset account are also balanced on the segment level. In this manner, the database of the central bookkeeping department provides any data required for including expenses and earnings of individual organizational units of an enterprise and for preparing a balance sheet for internal reports if necessary.

In a first step, totals entries containing in a totals data part a total of posting amounts of a posting account of the document data records are generated in a totals table, in order to prepare a financial statement with the document data records saved to the database. These totals entries are automatically updated at regular intervals, so as to include new document data records that have been added in the meantime. However, they can also be completely recalculated at preset points in time.

A totals entry can be generated for each organizational unit, each general ledger, each company code, each posting period, and each posting account, wherein further classifications can be set in a flexible manner. These additional classifications can be set separately for each general ledger, i.e., for each statutory accounting principle. Thereby, a transaction report or an internal report can be prepared easily and quickly for each statutory accounting principle, which is represented by the respective general ledger, as defined by the central management of the group. In the next step, a balance sheet can be prepared for each relevant statutory accounting principle, based on the individual totals entries. This can be achieved automatically, because the individual totals entries that are related to a specific general ledger each correspond to a specific statutory accounting principle.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets or in SAP R/3 or ABAP. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

1. A computer-implemented method for creating a database for accounting purposes, such as for preparing financial statements of an enterprise, the method comprising:
saving document data records from posting documents to a document database, the document data records comprising a document header and a data part, the data part comprising entries for at least two items, each of which comprises a posting amount and an account assigned thereto;
calculating totals from one or more posting amounts of the document data records saved for the accounts assigned thereto, wherein prior to calculating the totals for the totals entries of the totals table, at least one item of the document data record is assigned proportionately to two or more organizational units of the enterprise, and wherein partial items are generated from the at least one item according to computer-implemented rules; and
saving the totals to totals entries of a totals table, at least one total being saved to each of the totals entries for each organizational unit to which one or more partial items are assigned,
wherein, in the partial items, the posting amount of the item is subdivided in proportionate partial amounts and each partial item, along with its partial amount, is assigned to one of the organizational units, and
further wherein the totals for the organizational units are only calculated with posting amounts originating from items or partial items that are assigned to the particular organizational unit concerned.

2. The method according to claim 1, wherein the method further comprises checking, for at least one of the accounts and its related offset account for at least one of the organizational units, whether the total of the posting amounts of the items and partial items assigned to the account for the organizational unit is equal to the total of the posting amounts of the items and partial items assigned to the related offset account for the organizational unit and, if this is not the case, generating a corrective accounting data record comprising an item used to balance a difference between the two totals by means of an offset posting entry, whereby the account and the offset account are balanced.

3. The method according to claim 1, wherein a document date or a posting date are entered in the document header of the document data records.

4. The method according to claim 1, wherein a split time at which the partial items were generated is entered in the document header of the document data records.

5. The method according to claim 1, wherein information on which partial items were generated for which document data records is saved in a split information table.

6. The method according to claim 5, wherein the method further comprises saving the partial amounts of the partial items or their relations in the split information table with specification of the organizational units assigned thereto.

7. The method according to claim 5, wherein the split information table refers to rules which were used to generate the partial items.

8. The method according to claim 5, wherein the method further comprises checking whether the document number of a second document data record is additionally saved in a first document data record and, if so, enriching the data part of the first document data record is by the generation of partial items by means of the split information table, wherein, in the partial items, the posting amount of the first document data record is allocated to the same organizational units to which the corresponding partial amounts are assigned in the second document data records, the allocation taking place in partial amounts which correspond to the proportion of the partial amounts of the second document data record or the rules used.

9. The method according to claim 1, wherein the method further comprises providing an input mask with the input fields of the document header being arranged above the input fields of the data part.

10. The method according to claim 1, wherein the general ledger or general ledgers to which the related single item entry is relevant can be entered in a further input field of the document header.

11. The method according to claim 10, wherein a document data record the further input field of which does not contain any entry will be considered for all general ledgers.

12. The method according to claim 1, wherein a company code is entered in the document header of the document data records.

13. A computer-readable medium comprising software which can be loaded to the memory of a digital computer and which can be used to carry out the steps of a method when the software is executed on a computer, the method comprising:
saving document data records from posting documents to a document database, the document data records comprising a document header and a data part, the data part comprising entries for at least two items, each of which comprises a posting amount and an account assigned thereto;
calculating totals from one or more posting amounts of the document data records saved for the accounts assigned thereto, wherein prior to calculating the totals for the totals entries of the totals table, at least one item of the document data record is assigned proportionately to two or more organizational units of the enterprise, and wherein partial items are generated from the at least one item according to computer-implemented rules; and
saving the totals to totals entries of a totals table, at least one total being saved to each of the totals entries for each organizational unit to which one or more partial items are assigned,
wherein, in the partial items, the posting amount of the item is subdivided in proportionate partial amounts and each partial item, along with its partial amount, is assigned to one of the organizational units, and
further wherein the totals for the organizational units are only calculated with posting amounts originating from items or partial items that are assigned to the particular organizational unit concerned.

14. The computer-readable medium according to claim 13, wherein the method further comprises checking, for at least one of the accounts and its related offset account for at least one of the organizational units, whether the total of the posting amounts of the items and partial items assigned to the account for the organizational unit is equal to the total of the posting amounts of the items and partial items assigned to the related offset account for the organizational unit, and if this is not the case, generating a corrective accounting data record comprising an item used to balance a difference between the two totals by means of an offset posting entry, whereby the account and the offset account are balanced.

15. The computer-readable medium according to claim 13, wherein a document date or a posting date are entered in the document header of the document data records.

16. The computer-readable medium according to claim 13, wherein a split time at which the partial items were generated is entered in the document header of the document data records.

17. The computer-readable medium according to claim 13, wherein information on which partial items were generated for which document data records is saved in a split information table.

18. The computer-readable medium according to claim 17, wherein the method further comprises saving the partial amounts of the partial items or their relations in the split information table with specification of the organizational units assigned thereto.

19. The computer-readable medium according to claim 17, wherein the split information table refers to rules which were used to generate the partial items.

20. The computer-readable medium according to claim 17, wherein the method further comprises checking whether the document number of a second document data record is additionally saved in a first document data record and, if so, enriching the data part of the first document data record by the generation of partial items by means of the split information table, wherein, in the partial items, the posting amount of the first document data record is allocated to the same organizational units to which the corresponding partial amounts are assigned in the second document data records, the allocation taking place in partial amounts which correspond to the proportion of the partial amounts of the second document data record or the rules used.

21. The computer-readable medium according to claim 13, wherein the method further comprises providing an input mask with the input fields of the document header being arranged above the input fields of the data part.

22. The computer-readable medium according to claim 13, wherein the general ledger or general ledgers to which the related single item entry is relevant can be entered in a further input field of the document header.

23. The computer-readable medium according to claim 22, wherein a document data record the further input field of which does not contain any entry will be considered for all general ledgers.

24. The computer-readable medium according to claim 13, wherein a company code is entered in the document header of the document data records.

25. A data structure of an electronic accounting document comprising a document header and a data part with items, wherein, in the data part, two or more items are assigned to two or more organizational units of an enterprise.
